(19) United States
(12) Patent Application Publication
(10) Pub. No.: US 2018/0187276 A1
(43) Pub. Date: Jul. 5, 2018

(54) Slag Conditioner

(71) Applicant: ISM, Inc., Mars, PA (US)

(72) Inventor: Joseph L. Stein, Gibsonia, PA (US)

(21) Appl. No.: 15/857,707

(22) Filed: Dec. 29, 2017

Related U.S. Application Data
(60) Provisional application No. 62/440,455, filed on Dec. 30, 2016.

(51) Int. Cl. C21C 7/076; C21C 7/00; C21C 5/52; C21C 5/54; C22B 1/242; C01B 32/20; C01B 32/30; C01F 5/02; C01F 11/02

(52) U.S. Cl. CPC C21C 7/076; C21C 7/0025; C21C 7/0006; C21C 5/5211; C21C 5/54; C01P 2004/60; C01B 32/20; C01B 32/30; C01F 5/02; C01F 11/02; C22B 1/242

(57) ABSTRACT

A slag conditioner including 20-90 wt. % carbonaceous material with the balance being an MgO-containing material having at least 50% MgO as periclase, wherein the MgO(total):C weight ratio is 0.05-0.4. The slag conditioner may further comprise a CaO-containing material. The slag conditioner may be a particulate comprising particles of carbonaceous material mixed with particles of MgO-containing materials, may be in pellet form, or may be a briquette. Also, a method of conditioning the slag in an electric arc furnace including injecting the particulate slag conditioner or the pellet slag conditioner discussed above into the slag or into an interface between the slag and the molten metal or charging the briquette slag conditioner discussed above into the top of the furnace.

### CROSS-REFERENCE TO RELATED APPLICATION

This application claims priority to U.S. Provisional Application Ser. No. 62/440,455, filed Dec. 30, 2016, which is hereby incorporated by reference in its entirety.

### BACKGROUND OF THE INVENTION

### Field of the Invention

The present invention relates to compositions useful for the making of steel, and more particularly, to the composition of a slag conditioner, a method for producing such a slag conditioner, and a method of conditioning slag in an electric furnace using such slag conditioner.

### Background of the Invention

Prior to 1960, silica brick was primarily used in the refractory linings of steelmaking furnaces such as electric arc furnaces (“EAFs”). The silica brick was compatible with the acidic silicon dioxide (SiO₂) produced in the slag of the steelmaking process, resulting in extended life of the refractory lining. As demand for steel grew, however, refractory linings became unable to keep pace with the increased use of the furnaces using increased operating temperatures, and the lifespan of refractory linings were significantly shortened. Such shortcomings increased the amount of downtime for repairs and maintenance and increased the costs of producing steel.

As the need for improved refractory linings became more pressing, a change from silicon dioxide linings to more basic linings based on magnesium oxide (MgO) and calcium oxide (CaO) grew in popularity. These refractory linings were principally composed of burned dolomite and/or dead burned magnesite. Because these new linings were substantially more basic than the previously utilized silica linings, the composition of slag had to be changed.

Molten slag is ionic in nature, consisting both of cations and anions. The principal anion in slag is silicate as contributed by impurities in the scrap, and the basic building block of this silicate is the silicate tetrahedron (SiO₄⁴⁻). The addition to the slag of, among other metal oxides, CaO and MgO, results in a breakdown of the tetrahedron structure forming liquid silicate compounds. The addition of CaO to slag is important for a number of reasons. First, it makes the slag more basic for improved interaction with the refractory lining and increasing lining durability. Second, CaO improves the ability of the slag to remove impurities from the liquid steel. It was noted, however, that the weight percent ratio of CaO to SiO₂ (C/S weight ratio) present in the slag at the conclusion of steelmaking impacts the level of MgO needed for the process because MgO is soluble in calcium silicate liquid slags, which also contain other oxides such as FeO and Al₂O₃. A CaO/SiO₂ molar ratio (C/S mol ratio) of greater than 2-to-1 requires a significant percentage of MgO to be present in the slag. If the required percentage is not present, the process leaches the additional quantity of MgO from the refractory lining of the furnace, resulting in decreased lining durability. A C/S mol ratio of less than 2-to-1 also dissolves MgO at a higher rate and is to some extent dependent on the FeO content. Thus, it became common practice to include higher amounts of MgO in the slag.

To satisfy this demand for increased MgO content in slag, steelmakers began adding higher levels of burned dolomite or a mixture of burned dolomite and burned limestone to the slag. This resulted in increased refractory lining lifespan. However, maintenance was still needed on a frequent basis, resulting in increased downtime for steelmaking furnaces.

To combat this downtime, steelmakers began to experiment further with slag, resulting in new compositions and a foaming slag. Adjusting the C/S weight ratio to between 1.7 and 2.1 increased the viscosity of the slag while also increasing the amount of MgO that is dissolved. Increasing the MgO concentration of the slag also made the slag more viscous. It was known, based on experiences in basic oxygen furnaces (“BOFs”), that increased viscosity increases the slag that splashes onto the refractory walls. This splashing effect protects the walls of the furnace from excessive wear and reduces downtime for the steelmaking furnaces.

Just increasing the viscosity was not enough in EAFs because special requirements exist with regard to slag in EAFs. For instance, slag splashed onto the walls of the furnace is necessary to protect the lining from electrical arc radiation. Additionally, the use of direct reduced iron in the steelmaking process and the use of liquids with low-melting temperature silicates, results in high MgO solubility and a need for increased MgO concentrations in the slag to prevent leeching of MgO from the refractory lining.

The amount of slag splashed onto the refractory lining of an EAF can be increased by the injection of oxygen gas into the steelmaking chamber. This gas and available FeO in the slag reacts with carbon present in coal or coke to form carbon monoxide (CO) and carbon dioxide (CO₂). The production of these gases forms bubbles in the slag, increasing the slag volume and creating a “foamy” slag which helps coat the electrodes and the refractory lining of the furnace walls.

Despite the advent of the use of foamy slag in EAFs, refractory lining lifespan, while improved, was still relatively short because of the issues detailed previously. A need for a higher MgO content in the slag for super saturation was identified, resulting in the use of dead burned MgO, containing up to 93% MgO in a coarse aggregate. The larger particle size of the coarse aggregate MgO allowed for the magnesium to remain in the furnace during the steelmaking process. However, the use of dead burned MgO increased the cost of producing steel.

Attempts were then made to improve the cost effectiveness of adding MgO to slag. One option was light burned MgO, a relatively low-cost additive. The light burned MgO was crushed and ground to a particular particle size, mixed with water, and compressed into briquettes. The briquettes were then allowed to dry and cure and contained on average about 65% MgO, with the remaining composition being ash and hydroxide. These briquettes, however, did not provide the noted advantages of dead burned MgO, such as foaming or splashing to allow for the coating of the refractory linings of the EAFs. Additional attempts to utilize the light burned form of MgO with additions of carbon through the use of coke were similarly unsuccessful.

With the advent of slag conditioners, efficiency in the production of steel has greatly improved. Despite this improvement, currently produced slag conditioners have shortcomings that may be remedied by the present invention.

### SUMMARY OF THE INVENTION

The present invention is directed to a slag conditioner comprising 20-90 wt. % carbonaceous material with the balance being an MgO-containing material having at least 50% MgO as periclase, the crystalline form of MgO, wherein the total MgO to carbon (MgO(total):C) weight ratio is 0.05-0.4. The carbonaceous material may be one or more material selected from the group consisting of anthracite coal, semi-anthracite coal, bituminous coal, natural graphite, synthetic graphite, petroleum coke, metallurgical coke, spent EAF electrodes, spent carbon anodes, and carbon black and may comprise at least 50 wt. % carbon. The MgO-containing material may be one or more material selected from the group consisting of dead burned dolomite, dead burned magnesite, dead burned brucite, fused dolomite, fused magnesite, fused brucite, recycled MgO-containing slags, and pre-fired MgO-containing refractories including recycled magnesium oxide-carbon refractory bricks, recycled magnesium oxide-spinel refractory bricks, recycled MgO-based tundish lining material, and recycled dead burned dolomite brick. The slag conditioner may further comprise a CaO-containing material wherein in the total MgO to CaO (MgO(total):CaO) weight ratio is 7-90. The CaO-containing material may be one or more material selected from the group consisting of quicklime, hydrated lime, lime, and limestone.

The slag conditioner may be a particulate comprising particles of carbonaceous material mixed with particles of MgO-containing materials and the carbonaceous material particles and the particles of MgO-containing materials may be 6 mm or less.

The slag conditioner may be in pellet form and may further comprise 3-10 wt. % of a binder. The pellets may be 6 mm or less.

The slag conditioner may be a briquette and may further comprise 3-10 wt. % of a binder.

The present invention is also directed to a method of conditioning the slag in an electric arc furnace comprising injecting the particulate slag conditioner or the pellet slag conditioner discussed above into the slag or into an interface between the slag and the molten metal; charging the briquette slag conditioner discussed above into the top of the furnace; or introducing MgO-containing material into the handling system between the storage container for the carbonaceous material and the point of injection into the furnace.

### DESCRIPTION OF THE INVENTION

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. For example, a range of “1 to 10” is intended to include any and all sub-ranges between and including the recited minimum value of 1 and the recited maximum value of 10, that is, all subranges beginning with a minimum value equal to or greater than 1 and ending with a maximum value equal to or less than 10, and all subranges in between, e.g., 1 to 6.3, or 5.5 to 10, or 2.7 to 6.1. Plural encompasses singular and vice versa. When ranges are given, any endpoints of those ranges and/or numbers within those ranges can be combined with the scope of the present invention. “Including”, “such as”, “for example” and like terms means “including/such as/for example but not limited to”.

All compositions are given in weight percent unless specifically stated otherwise. All ratios are in terms of weight unless specifically stated otherwise.

The present invention is directed to a slag conditioner comprising magnesium oxide (MgO) and carbon that may be injected into the slag layer or the slag/metal interface of an electric arc furnace (EAF) or charged into the top of an EAF. At least 50% of the MgO contained in the slag conditioner is periclase. As used herein, periclase is defined as the cubic crystalline, non-reactive or less reactive form of MgO that can be identified using X-ray diffraction and remains in solid form when introduced into the slag.

The slag conditioner comprises a carbon source and an MgO source and may optionally comprise additional ingredients including a source of calcium oxide (CaO), a binder, and/or other compatible fillers.

The slag conditioner may comprise at least 20 wt. % carbonaceous material and up to 90 wt. % carbonaceous material, for example, 20-90 wt. % carbonaceous material, 20-80 wt. % carbonaceous material, or 70-90 wt. % carbonaceous material, with the balance being an MgO-containing material having at least 50%, for example, at least 60% or at least 70%, of the MgO as periclase. The carbonaceous material and the MgO-containing material are contained in amounts such that the total MgO to carbon (MgO(total):C) weight ratio of the slag conditioner is 0.05-0.4, for example, 0.1-0.4 or 0.1-0.3. MgO(total) is herein defined as the total MgO content of the MgO-containing material including MgO in the form of periclase and in any other form.

The carbonaceous material may be one or more material selected from anthracite coal, semi-anthracite coal, bituminous coal, natural graphite, synthetic graphite, petroleum coke, metallurgical coke, spent EAF electrodes, spent carbon anodes, and carbon black. The carbonaceous material may contain up to 15 wt. % moisture, for example, 5-12 wt. % moisture, and at least 50 wt. % carbon, for example, at least 70 wt. % carbon or 75-99 wt. % carbon. For example, metallurgical coke may have 5-6% moisture and coal may have 8-12% moisture. Carbonaceous materials having moisture contents of 2% or greater may be pre-dried or may be used without drying when making slag conditioner in the form of pellets or briquettes. If the carbonaceous material is not dried, the pellets or briquettes may be dried after mixing and forming. The carbonaceous material may comprise particles of sufficiently small size to be transportable through a pneumatic pipe injection system into the furnace, small enough to be incorporated into the slag and not into the steel, and large enough that, when injected into the steelmaking furnace, the particles are not deflected by furnace draft. For example, the particles, when screened may be 12 mm or less in diameter, 10 mm or less in diameter, or 3 mm or less in diameter, i.e., the particles, for example, pass through a mesh having 12 mm, 10 mm, or 3 mm openings, respectively. For example, the carbonaceous material may be #4 anthracite coal (1.2-2.4 mm) or #5 anthracite coal (0.15-1.2 mm), or may be petroleum coke particles that are less than 12 mm. Very fine particles, 63 μm (230 mesh) may be limited to 15% or less except for carbon or MgO-containing materials that are to be a component of a pelletized product. Materials used for pellet making have no practical limit on particle size since fine particles will be agglomerated with binders in the mixing process.

The MgO-containing material may be any material where at least 50% of the contained MgO is periclase and may be one or more material selected from the group including, but not limited to, dead burned dolomite, dead burned magnesite, dead burned brucite, fused dolomite, fused magnesite, fused brucite, recycled MgO-containing slags, and pre-fired MgO-containing refractories including recycled magnesium oxide-carbon refractory bricks, recycled magnesium oxide-spinel refractory bricks, recycled MgO bricks, recycled magnesia-alumina-carbon bricks, recycled MgO-based tundish lining material, and recycled dead burned dolomite brick. The pre-fired MgO-containing refractories may contain dead burned dolomite, dead burned magnesite, fused MgO, and/or fused dolomite.

Dead burned dolomite as used herein is defined as dolomite, calcium magnesium carbonate (CaMg(CO₃)₂), that has been calcined or burned at 1500-2000° C., thereby forming MgO as periclase. Dead burned magnesite as used herein is defined as magnesite, magnesium carbonate (MgCO₃), that has been calcined or burned at 1500-2000° C., thereby forming MgO as periclase. Dead burned brucite as used herein is defined as brucite, magnesium hydroxide (MgOH₂), that has been calcined or burned at 1500-2000° C., thereby forming MgO as periclase. Fused dolomite as used herein is defined as dolomite, calcium magnesium carbonate (CaMg(CO₃)₂), that has been calcined or burned at >2750° C., thereby forming MgO as periclase. Fused magnesite as used herein is defined as magnesite, magnesium carbonate (MgCO₃), that has been calcined or burned at >2750° C., thereby forming MgO as periclase. Fused brucite as used herein is defined as brucite, magnesium hydroxide (MgOH₂), that has been calcined or burned at >2750° C., thereby forming MgO as periclase.

The MgO-containing material may comprise particles that, when screened, are 8 mm or less, for example, 6 mm or less, 3 mm or less (˜7 mesh), 1.5 mm or less (˜14 mesh), 0.5 mm or less (35 mesh), or 0.25 mm or less (60 mesh), i.e., the particles pass through a mesh having openings of 6 mm, 3 mm, 1.5 mm, 0.5 mm, or 0.25 mm, respectively. The MgO-containing material may comprise particles that are similar in size to the particles of carbonaceous material, for example, 3 mm or less, if the slag conditioner is to be injected into the slag without being pelletized. If the slag conditioner is to be pelletized, the MgO-containing material may comprise particles that are similar in size to the particles of carbonaceous material or are smaller than the particles of carbonaceous material.

The slag conditioner may optionally include at least a CaO-containing material. The CaO-containing material is contained in an amount such that the total MgO to CaO (MgO(total):CaO) weight ratio is 7-90, for example, 7-50 or 10-70. The CaO-containing material may be one or more selected from the group including, but not limited to, recycled slag, slag contamination from recycled spent refractories, quicklime, hydrated lime, lime, and limestone. Quicklime as used herein is defined as calcium oxide (CaO) and may also be referred to as burnt lime. Hydrated lime as used herein is defined as calcium hydroxide (Ca(OH)₂). Lime as used herein is defined as calcium oxide (CaO). Limestone as used herein is defined as calcium carbonate (CaCO₃). The CaO-containing material may comprise particles that are similar in size to the MgO-containing material, i.e., 3 mm or less (˜7 mesh), for example, 1.5 mm or less (˜14 mesh), 0.5 mm or less (35 mesh), or 0.25 mm or less (60 mesh).

Iron oxide and other compatible fillers up to 25 wt. % may be added depending on the desired effects on the slag. Iron oxide is added, especially when stainless steels are being melted, to prevent low iron slags from reacting with the injected oxygen thereby reducing the amount of oxygen reacting with the alloying elements and/or the carbon to foam the slag.

In one aspect of the invention, the carbonaceous material particles and the MgO-containing material particles, along with any optional additives may be mixed, and the resulting slag conditioner may be injected directly into the slag in aggregate or powder form. The injection may be accomplished using already existing carbon injection equipment such as the equipment made by ISIS Company or Badische Stahl Engineering GmbH (BSE). In this case, the slag conditioner contains no more than 5% moisture, for example, no more than 2% moisture.

In another aspect of the invention, the slag conditioner may be pelletized before injection. In order to pelletize the slag conditioner, at least 3 wt. % of a binder and not more than 14 wt. % of a binder, for example, 3-14 wt. % of a binder or 5-14% of a binder is added to carbonaceous material and the MgO-containing material. The binder may be one or more material selected from the group including, but not limited to, sodium silicate, ligosulfonate, lignosulfonate solutions, hydrochloric acid, sulfuric acid, magnesium chloride, magnesium sulfate, molasses, pitch, tar, asphalt, bentonite, clay, and resin.

The carbonaceous material, the MgO-containing material, and the binder are blended in any suitable mixer having an impeller or mixing blades, for example, an Eirich mixer, a Day mixer, a barrel mixer, or a ribbon mixer. More specifically, the carbonaceous material may first be added to the mixer and then the binder is added. The composition is mixed to form a non-free-flowing paste. Water may be added as needed to adjust the viscosity of the mixture. The MgO-containing material and the optional CaO-containing material is then added and the finer MgO-containing material particles and optional CaO-containing material particles coat the larger carbonaceous material particles. The material agglomerates forming individual pellets. Such a process is often referred to as a granulation process. The resulting pellets may be screened to produce a final slag conditioner having pellets that are at most 13 mm, for example, at most 7 mm, and at least 0.25 mm, for example, at least 0.5 mm. At least 85% of the particles may be at least 0.25 mm, for example, at least 0.5 mm.

In another aspect of the invention, the carbonaceous material, MgO-containing material, and binder may be agglomerated and briquetted or extruded to form larger briquettes or lumps that can be directly charged into the top of the furnace. For example, the briquettes may be 5-8 cm by 1-2 cm. In this method, the carbon included in the slag conditioner may substitute for all or some of the charge carbon that is needed to supply the necessary amount of carbon in the steel. The carbonaceous material in this case may be, for example, coal, petroleum coke, or metallurgical coke.

In another aspect of the invention, the briquettes or lumps may be crushed to form pellets of the size previously described.

In another aspect of the invention, the carbonaceous material and the MgO-containing material may be directly charged into the top of the furnace. In this method, the carbon included in the slag conditioner may substitute for all or some of the charge carbon that is needed to supply the necessary amount of carbon in the steel. The carbonaceous material in this case may be, for example, coal, petroleum coke, or metallurgical coke. The MgO-containing material may comprise particles that are similar or smaller in size to the particles of carbonaceous material, for example, 8 mm or less.

In another aspect of the invention, the MgO-containing material may be introduced into the handling system between the storage container for the carbonaceous material and the point of injection into the furnace.

### Example 1—Slag Conditioner Pellets

80 wt. % #5 anthracite coal having a particle size of 3/64 of an inch or less and containing about 10% moisture and about 80 wt. % carbon was placed in a small sunbeam mixer, 4 wt. % of quicklime was added and the composition was mixed. 6 wt. % of molasses having a 60% solids concentration was blended into the coal/quicklime mixture. 10 wt. % recycled Magnesium-Carbon and MgO-Spinel bricks having about 70% MgO, with greater than 85% of the MgO being periclase, were ground and screened to 35 mesh (0.5 mm or less) and added to the mixer. After a few minutes of mixing small pellets were formed. The pellets were then dried at 220° F. for one hour. The resulting slag conditioner pellets were 3 mm×1 mm with a few larger pellets and some residual fine material. The pellets were of a size that could be injected with existing equipment found in essentially all electric furnace shops worldwide. The pellets had an MgO(total):C weight ratio of 0.12.

### Example 2—Slag Conditioner Pellets

75 wt. % #5 anthracite coal having a particle size of 3/64 of an inch or less and containing about 10% moisture and about 80 wt. % carbon was placed in a small sunbeam mixer, 4 wt. % of hydrated lime was added and the composition was mixed. 6 wt. % of molasses having a 60% solids concentration was blended into to the coal/lime mixture. 15 wt. % recycled Magnesium-Carbon and MgO-Spinel bricks having about 70% MgO, with greater than 85% of the MgO being periclase, were ground and screened to 35 mesh (0.5 mm or less) and added to the mixer. After a few minutes of mixing small pellets were formed. The pellets were then dried at 220° F. for one hour. The resulting slag conditioner pellets were 3 mm×1 mm with a few larger pellets and some residual fine material. The pellets were of a size that could be injected with existing equipment found in essentially all electric furnace shops worldwide. The pellets had an MgO(total):C weight ratio of 0.19.

In use, in an EAF, the slag conditioner may provide 0.5-4% excess MgO to the slag primarily as periclase. For example, a typical calcium silicate slag accounts for about 10% of the tap steel weight, which is 10 net tons of slag or 20,000 pounds of slag per 100 net tons of steel. The MgO required to saturate the slag depends on the CaO:SiO₂. For a typical CaO:SiO₂ weight ratio of 2:1, the required MgO for saturation is about 10% such that 1 net ton or 2000 pounds of MgO would be needed, usually provided by addition of burned dolomite in the charge. In order to provide 2% excess MgO, an additional 400 pounds of MgO would be needed or an additional ˜570 pounds of MgO-containing material having 70% MgO. Assuming that the required carbonaceous material for injection and foaming at 80% carbon is 20 pounds per net ton, the carbonaceous material for 100 net tons of steel would be 2000 pounds. If the excess MgO is supplied with the injection carbon using the slag conditioner of the present invention, the slag conditioner will contain the 400 pounds of MgO and the 2000 pounds of carbonaceous material resulting in a slag conditioner having an MgO(total):C weight ratio of 0.25. In addition, the provided excess MgO from the slag conditioner will be at least 50% periclase.

The slag conditioner of the present invention requires less soluble MgO to saturate the slag than the prior art while maintaining sufficiently increased slag viscosity via the MgO as periclase, thereby creating a creamy slag that coats the refractory linings of the EAF walls, thus, increasing lining lifespan. In addition, the slag conditioner utilizes less carbon than the prior art because the coating of the refractory lining is enhanced by the MgO present as periclase, thereby reducing the carbon that is needed for foaming. The slag conditioner is also more effective than the prior art additives because a synergistic effect is achieved by providing both carbon and MgO directly in the same location.

Whereas particular aspects of this invention have been described above for purposes of illustration, it will be evident to those skilled in the art that numerous variations of the details of the present invention may be made without departing from the invention as defined in the appended claims.

The invention claimed is:

1. A slag conditioner comprising:
20-90 wt. % carbonaceous material with the balance being an MgO-containing material having at least 50% MgO as periclase, wherein the total MgO to carbon (MgO(total):C) weight ratio for the slag conditioner is 0.05-0.4.

2. The slag conditioner of claim 1, wherein the carbonaceous material is one or more material selected from the group consisting of anthracite coal, semi-anthracite coal, bituminous coal, natural graphite, synthetic graphite, petroleum coke, metallurgical coke, spent EAF electrodes, spent carbon anodes, and carbon black.

3. The slag conditioner of claim 1, wherein the carbonaceous material comprises at least 50 wt. % carbon.

4. The slag conditioner of claim 1, wherein the MgO-containing material is one or more material selected from the group consisting of dead burned dolomite, dead burned magnesite, dead burned brucite, fused dolomite, fused magnesite, fused brucite, recycled MgO-containing slags, and pre-fired MgO-containing refractories including recycled magnesium oxide-carbon refractory bricks, recycled magnesium oxide-spinel refractory bricks, recycled MgO bricks, recycled magnesia-alumina-carbon bricks, recycled MgO-based tundish lining material, and recycled dead burned dolomite brick.

5. The slag conditioner of claim 1, further comprising a CaO-containing material, wherein the total MgO to CaO (MgO(total):CaO) weight ratio for the slag conditioner is 7-90.

6. The slag conditioner of claim 5, wherein the CaO-containing material is one or more material selected from the group consisting of recycled slag, slag contamination from recycled spent refractories, quicklime, hydrated lime, lime, and limestone.

7. The slag conditioner of claim 1, wherein the slag conditioner is a particulate comprising particles of carbonaceous material mixed with particles of MgO-containing materials.

8. The slag conditioner of claim 7, wherein the particles of carbonaceous material particles and the particles of MgO-containing materials are 6 mm or less.

9. The slag conditioner of claim 1, wherein the slag conditioner is in pellet form.

10. The slag conditioner of claim 9, further comprising 3-14 wt. % of a binder.

11. The slag conditioner of claim 9, wherein the pellets are 6 mm or less.

12. The slag conditioner of claim 1, wherein the slag conditioner is a briquette.

13. The slag conditioner of claim 12, further comprising 3-14 wt. % of a binder.

14. A method of conditioning the slag in an electric arc furnace comprising injecting the slag conditioner of claim 7 into the slag or into an interface between the slag and the molten metal.

15. The method of claim 14, wherein the MgO-containing material is mixed with the carbonaceous material in the handling system between the storage container for the carbonaceous material and the point of injection into the slag or into an interface between the slag and the molten metal.

16. A method of conditioning the slag in an electric arc furnace comprising injecting the slag conditioner of claim 9 into the slag or into an interface between the slag and the molten metal.

17. A method of conditioning the slag in an electric arc furnace comprising charging the slag conditioner of claim 12 into the top of the furnace.
